(19) United States
(12) Patent Application Publication
(10) Pub. No.: US 2012/0194703 A1
(43) Pub. Date: Aug. 2, 2012

(54) APPARATUS

(75) Inventors: Radu Ciprian Bilcu, Tampere (FI); Miska Hannuksela, Ruutana (FI); Sakari Alenius, Lempaala (FI); Markku Vehvilainen, Tampere (FI)

(73) Assignee: NOKIA CORPORATION, Espoo (FI)

(21) Appl. No.: 13/394,771

(22) PCT Filed: Sep. 7, 2009
(86) PCT No.: PCT/EP2009/061551

§ 371 Date: Apr. 18, 2012

(51) Int. Cl. H04N 5/228; H04N 5/76

(52) U.S. Cl. 348/231.99; 348/222.1; 348/E05.031; 348/E05.024

(57) ABSTRACT

An apparatus comprising: a camera module configured to capture a first image of a subject with a first image capture parameter and at least one further image of substantially the same subject with at least one associated further image capture parameter; a reference image encoder configured to encode the first image into a first encoded image; a further image encoder configured to encode the at least one further image into at least one further encoded image; and a file compiler configured to combine the first encoding image and the at least one further encoded image into a first file.

The present application relates to a method and apparatus. In some embodiments the method and apparatus relate to image processing and in particular, but not exclusively limited to, some further embodiments relate to multi-frame image processing.

Imaging capture devices and cameras are generally known and have been implemented on many electrical devices. Multi-frame imaging is a technique which may be employed by cameras and image capturing devices. Such multi-frame imaging applications are, for example, high or wide dynamic range imaging in which several images of the same scene are captured with different exposure times and then can be combined to a single image with better visual quality. The use of high dynamic range/wide dynamic range applications allows the camera to then filter the intense back light surrounding and on the subject and enhance the ability to distinguish features and shapes on the subject. Thus, for example where light enters a room from various angles, a camera placed on the inside of a room will be able to see through the intense sunlight or artificial light entering the room and see the subject within the room. Traditional single frame images do not provide an acceptable level of performance as they will either produce an image which is too dark to show the subject or the background is washed out by the light entering the room.

Another multi-frame application is multi-frame extended depth of focus or field applications where several images of the same scene are captured with different focus settings. In these applications, the multiple frames can be combined to obtain an output image which is sharp everywhere.

A further multi-frame application is multi-zoom multi-frame applications where several images of the same scene are captured with differing levels of optical zoom. In these applications the multiple frames may be combined to permit the viewer to zoom into an image without suffering from a lack of detail produced in single frame digital zoom operations.

Much effort has been put into attempting to find efficient methods for combining the multiple images into a single output image. However, current approaches preclude later processing which may produce better quality outputs.

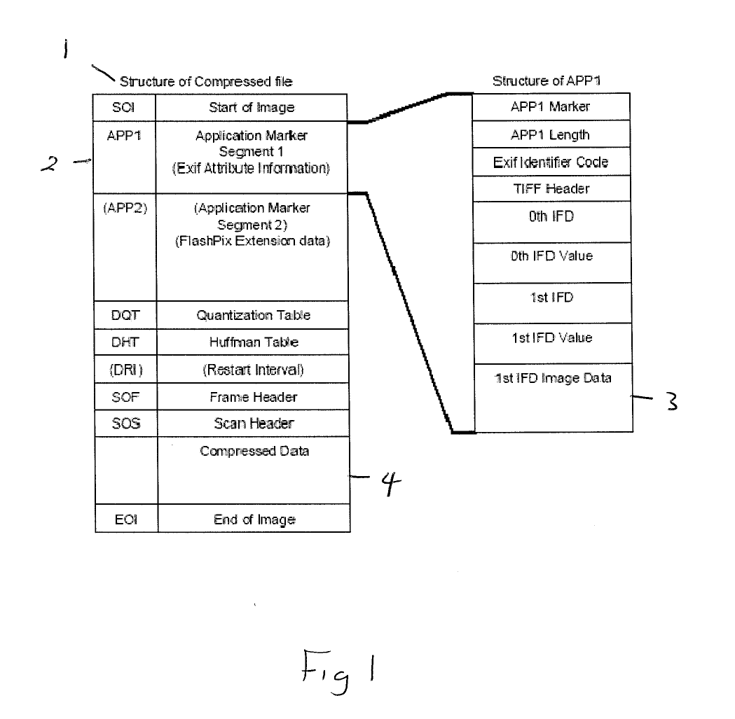

The storing of multiple images in original raw data formats although allowing later processing/viewing is problematic in terms of the amount of memory required to store all of the images. Furthermore it is of course possible to encode independently all of the captured images as separate encoded files and thus reduce the ‘size’ of each image and save all of the files. One such encoding system known is the joint photographic experts group JPEG encoding format. FIG. 1 shows a structure of a compressed file JPEG format where the structure table 1 shows a file structure element called ‘compressed data’ 4 which contains compressed image data according to the compression algorithm and parameters used. The file structure also shows an application marker segment 1 which within it contains a first image file directory (IFD) data field 3 which may contains an optional thumbnail image corresponding to the compressed full resolution image data.

By encoding separately and storing separately each image from the multi-frame image even when using compression like JPEG the use of memory is typically inefficient and furthermore the storing of multiple images of the same scene may be determined to be an error by the user as at first viewing these multiple images will appear to be similar to the user and may lead the user to delete some of these images by mistake.

This application therefore proceeds from the consideration that an improved multi-frame imaging processing structure or apparatus may be configured to more efficiently code and store the multi-frame images yet may also allow existing decoders to at least partially decode imaging files encoded using the apparatus.

According to a first aspect of the invention there is provided a method comprising capturing a first image of a subject with a first image capture parameter and at least one further image of substantially the same subject with at least one corresponding further image capture parameter; encoding the first image into a first encoded image; encoding the at least one further image into at least one further encoded image; and combining the first encoded image and the at least one further encoded image into a first file.

Encoding the at least one of the further image may comprise: decoding the first encoded image into a first decoded image; determining the differences between at least part of one of the at least one further image and at least part of the first decoded image; and encoding the differences between at least part of one of the at least one further image and at least part of the first decoded image.

Combining the first encoded image and the at least one further encoded image into a first file may comprise: configuring the first file be decodable according to a first algorithm and a second algorithm; the first encoded image being decodable into a first decoded image representing the first image according to the first algorithm and the second algorithm; and the at least one further encoded image being decodable into at least one further decoded image representing the at least one further image only according to the second algorithm.

Combining the first encoded image and the at least one further encoded image into a first file may comprise: logically linking the first encoded image and the at least one further encoded image in the first file.

Capturing the first image and the at least one further image is preferably in response to a user action.

Capturing the first image and the at least one further image may comprise capturing the first image and the at least one further image within a period, the period being perceived as a single event.

The first encoded image and the at least one further encoded image are preferably configured to share a same coded data structure.

The method may further comprise determining the number of at least one further images to be captured.

The method may further comprise selecting an image capture parameter value for each image to be captured.

Each image capture parameter may comprise at least one of: exposure time; focus setting; zoom factor; background flash mode; analog gain; and exposure value.

The method may further comprise inserting a first indicator in the first file indicating at least one of the first image capture parameter and the at least one further image capture parameter type.

The method may further comprise inserting at least one indicator in the first file indicating a value of at least one of the first image capture parameter and a value of the at least one of the at least one further image capture parameter.

Capturing a first image and the at least one further image may comprise at least one of: capturing the first image and subsequently capturing each of the at least one further image; and capturing the first image substantially at the same time as capturing each of the at least one further image.

According to a second aspect of the invention there is provided a method comprising decoding a first file comprising a first encoded image and at least one further encoded image, the first image having been captured of a subject with a first image capture parameter and the at least one further image having been captured of substantially the same subject with at least one further image capture parameter, wherein decoding the first file comprises: determining at least one of the first encoded image and the at least one further encoded image to be decoded; decoding the at least one of the first encoded image and the at least one further encoded image.

The method may further comprise: decoding the first encoded image by a first decoding algorithm to form a first decoded image; decoding the at least one further encoded image to generate at least one further image prediction data; and generating at least one further decoded image by combining the first decoded image and the at least one further image prediction data.

The first file preferably comprises: at least one first indicator indicating at least one of the first image capture parameter type and the at least one further image capture parameter type, and at least one second indicator indicating at least one of a first image capture parameter value and at least one further image capture parameter value; wherein the determining at least one of the first encoded image and the at least one further encoded image to be decoded comprises interpreting at least one of the first indicator the at least one second indicator.

The method may further comprise determining a number of decoded images from the first encoded file to be decoded, wherein the number of decoded images to be decoded is selected by a user.

All encoded images from the first encoded file are preferably decoded.

The method may further comprise selecting the encoded images from the first encoded file which are to be decoded, wherein the encoded images to be decoded are selected by the user.

According to a third aspect of the invention there is provided an apparatus comprising a camera module configured to capture a first image of a subject with a first image capture parameter and at least one further image of substantially the same subject with at least one associated further image capture parameter; a reference image encoder configured to encode the first image into a first encoded image; a further image encoder configured to encode the at least one further image into at least one further encoded image; and a file compiler configured to combine the first encoding image and the at least one further encoded image into a first file.

The further image encoder may comprise: an image decoder configured to decode the first encoded image into a first decoded image; a comparator configured to determine the differences between at least part of one of the at least one further image and at least part of the first decoded image; and a prediction encoder configured to encode the differences between at least part of one of the at least one further image and at least part of the first decoded image.

The file compiler may comprise an image linker configured to logically link the first encoded image and the at least one further encoded image in the first file.

The apparatus may further comprise an image capture interface for enabling the camera module.

The camera module is preferably further configured to capture the first image and the at least one further image within a period, the period being perceived as a single event.

The reference image encoder and the further image encoder are preferably configured to output the first encoded image and the at least one further encoded image with a same coded data structure.

The apparatus may further comprise a multi image frame determiner configured to determine the number of at least one further image to be captured.

The apparatus may further comprise a image capture parameter selector configured to select an image capture parameter value for each image to be captured.

Each image capture parameter may comprise at least one of: exposure time; focus setting; zoom factor; background flash mode; analog gain; and exposure value.

The apparatus may further comprise a parameter type indicator inserter configured to insert a first indicator in the first file indicating at least one of the first image capture parameter and the at least one further image capture parameter type.

The apparatus may further comprise an parameter value indicator inserter configured to insert at least one parameter value indicator in the first file indicating a value of at least one of the first image capture parameter and a value of the at least one of the at least one further image capture parameter.

The camera module is preferably configured to at least: capture the first image and subsequently one or more further images; and capture the first image substantially at the same time as capturing each of the further images.

According to a fourth aspect of the invention there is provided an apparatus configured to decode a first file comprising a first encoded image having been captured of a subject with a first image capture parameter and at least one further encoded image having been captured of substantially the same subject with at least one further image capture parameter, the apparatus comprising: a processor configured to determine at least one of the first encoded image and the at least one further encoded image to be decoded; and a decoder configured to decode the at least one of the first encoded image and the at least one further encoded image.

The decoder preferably comprises: a first decoder configured to decode the first encoded image by a first decoding algorithm to form a first decoded image; at least one further decoder configured to decode the at least one further encoded image to generate at least one image prediction data; and an image generator configured to generate at least one further decoded image by combining the first decoded image and the at least one image prediction data.

The first file may comprise: at least one first indicator indicating at least one of the first image capture parameter type and the at least one further image capture parameter type, and at least one second indicator indicating at least one of a first image capture parameter value and at least one further image capture parameter value; wherein the processor is configured to determine the at least one of the first encoded image and the at least one further encoded image to be decoded dependent on interpreting at least one of the first indicator the at least one second indicator.

The processor is preferably further configured to determine a number of decoded images from the first encoded file to be decoded, wherein the number of decoded images to be decoded is selected by a user.

All encoded images from the first encoded file are preferably decoded.

The processor is preferably further configured to select the encoded images from the first encoded file which are to be decoded, wherein the encoded images to be decoded are selected by the user.

Each of the at least one further decoder are preferably configured to decode an associated one of the at least one further encoded images to generate one or more image prediction data.

An electronic device may comprise apparatus as described above.

A chipset may comprise apparatus as described above.

A computer readable medium comprising a computer program thereon, the computer program may perform the method as described above.

According to a fifth aspect of the invention there is provided an apparatus comprising image capture means for capturing a first image of a subject with a first image capture parameter and one or more further images of substantially the same subject each with a corresponding image capture parameter; encoding means for encoding the first image into a first encoded image; second encoding means for encoding each of the further images into corresponding encoded images; and processing means for combining the first encoding image and at least one of the further encoded images into a first file.

According to a sixth aspect of the invention there is provided an apparatus comprising: receiving means for receiving a first file comprising a first encoded image and one or more further encoded images, wherein decoding the first file comprises: first decoding means for decoding the first encoded image by a first decoding algorithm to form a first decoded image; further decoding means for decoding at least one of the further encoded image to generate the corresponding image prediction data; and image generating means for generating one or more decoded images by combining the first decoded image and at least one of the corresponding image prediction data.

According to a seventh aspect of the invention there is provided an apparatus comprising at least one processor and at least one memory including computer program code the at least one memory and the computer program code configured to, with the at least one processor, cause the apparatus at least to perform: capturing a first image of a subject with a first image capture parameter and at least one further image of substantially the same subject with at least one corresponding further image capture parameter; encoding the first image into a first encoded image; encoding the at least one further image into at least one further encoded image; and combining the first encoded image and the at least one further encoded image into a first file.

According to an eighth aspect of the invention there is provided an apparatus comprising at least one processor and at least one memory including computer program code the at least one memory and the computer program code configured to, with the at least one processor, cause the apparatus at least to perform: decoding a first file comprising a first encoded image and at least one further encoded image, the first image having been captured of a subject with a first image capture parameter and the at least one further image having been captured of substantially the same subject with at least one further image capture parameter, wherein decoding the first file comprises: determining at least one of the first encoded image and the at least one further encoded image to be decoded; decoding the at least one of the first encoded image and the at least one further encoded image.

For a better understanding of the present application and as to how the same may be carried into effect, reference will now be made by way of example to the accompanying drawings in which:

FIG. 1 shows schematically the structure of a compressed image file according to a JPEG file format;

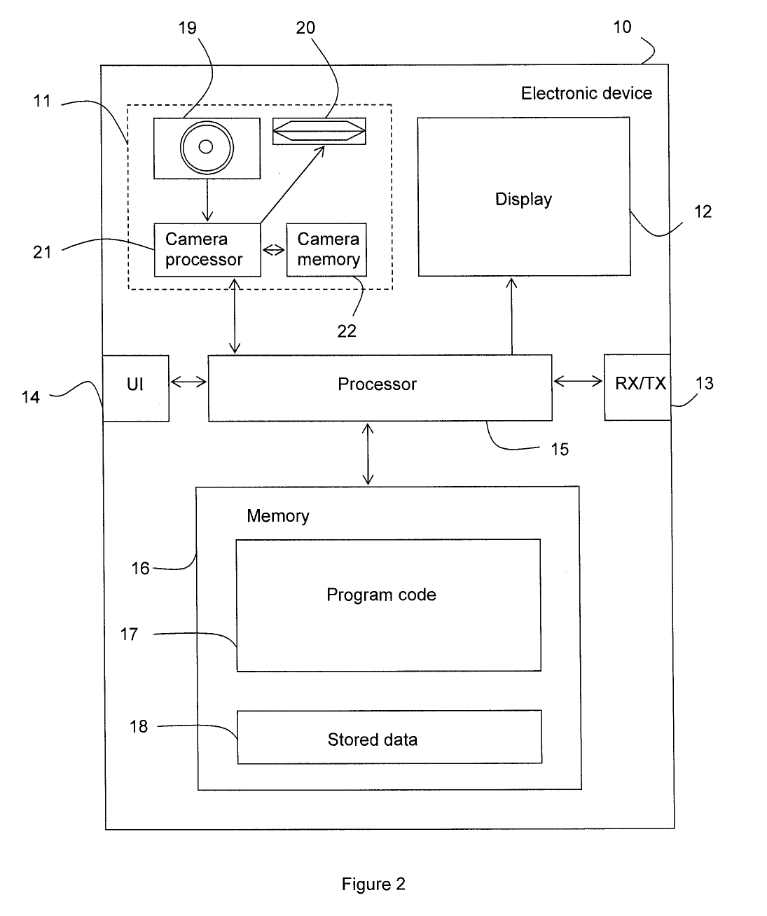

FIG. 2 shows a schematic representation of an apparatus suitable for implementing some embodiments of the application;

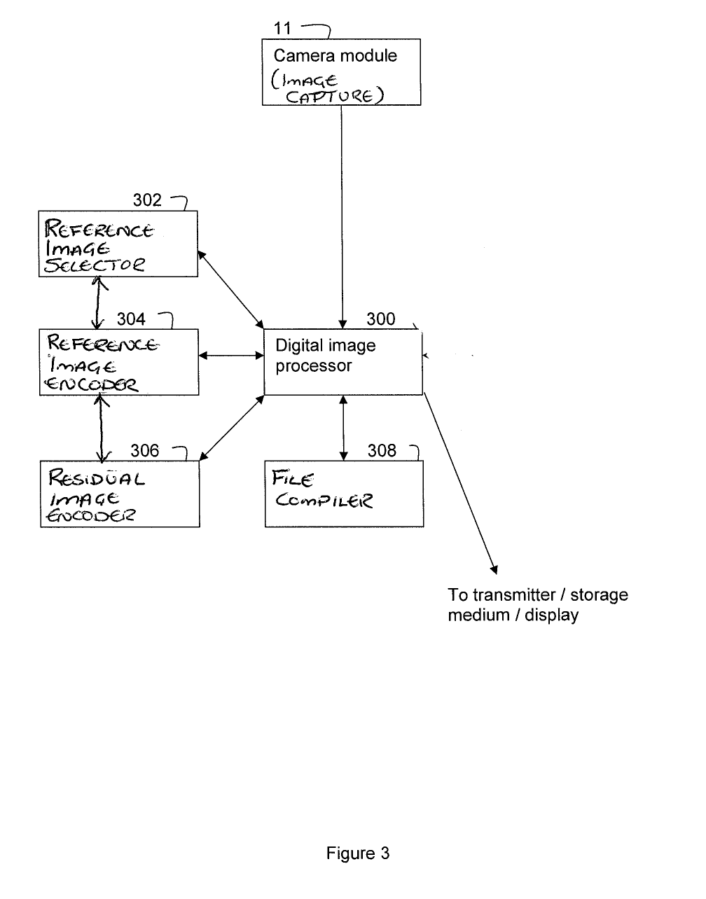

FIG. 3 shows a schematic representation of apparatus according to embodiments of the application;

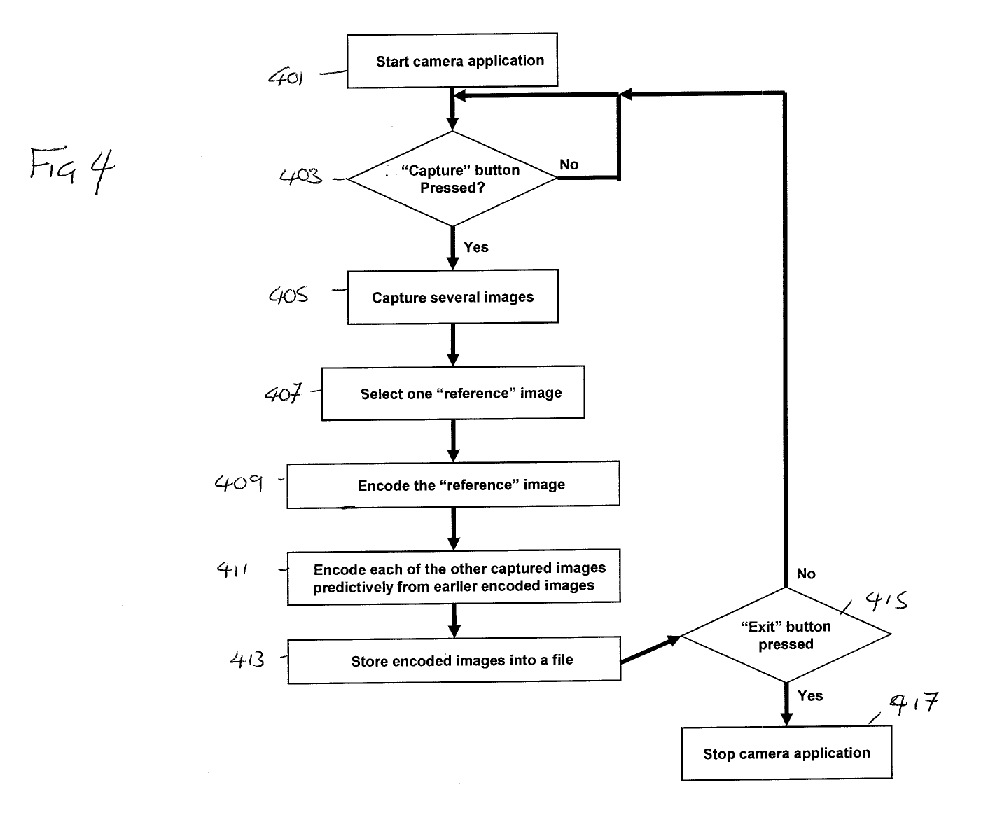

FIG. 4 shows a flow diagram of the processes carried out according to some embodiments.

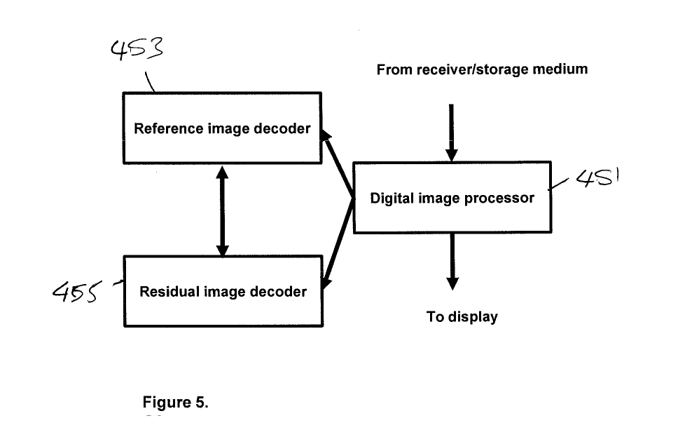

FIG. 5 shows a schematic representation of apparatus according to embodiments of the application;

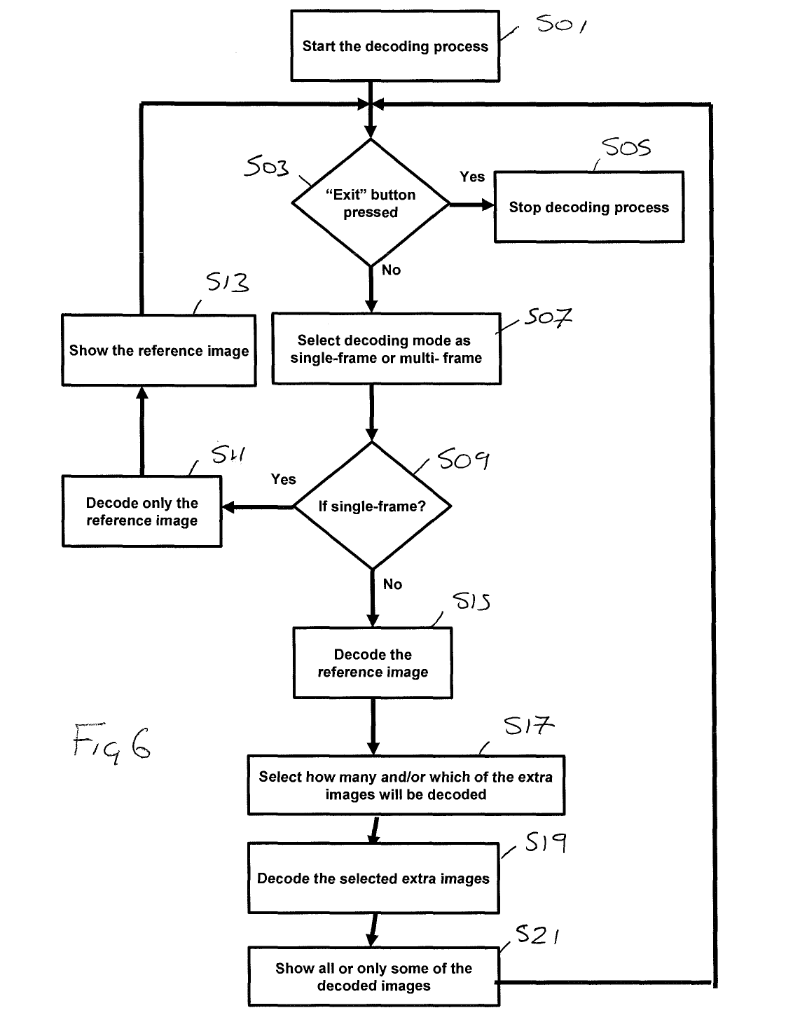

FIG. 6 shows a flow diagram of the process carried out according to some embodiments; and

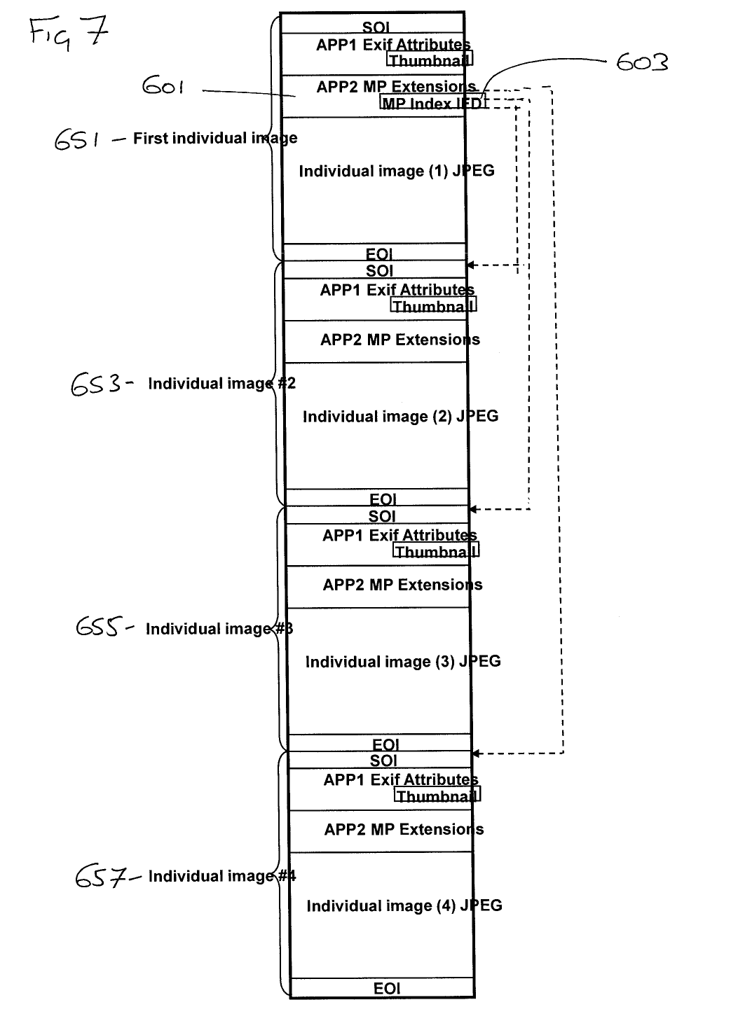

FIG. 7 shows schematically the structure of a compressed image file according to some embodiments of the application.

The application describes apparatus and methods to capture several static images of the same scene and encode them efficiently into one file. The embodiments described hereafter may be utilised in various applications and situations where several images of the same scene are captured and stored. For example, such applications and situations may include capturing two subsequent images, one with flash light and another without, taking several subsequent images with different exposure times, taking several subsequent images with different focuses, taking several subsequent images with different zoom factors, taking several subsequent images with different analogue gains, taking subsequent images with different exposure values. The embodiments as described hereafter store the images in a file in such a manner that existing image viewers may display the reference image and omit the additional images. Thus the main embodiment of the application is the concept of storing multiple images as described within a camera application framework.

The following describes apparatus and methods for the provision of improved multi-frame imaging techniques. In this regard reference is first made to FIG. 2 which discloses a schematic block diagram of an exemplary electronic device 10 or apparatus. The electronic device is configured to perform multi-frame imaging techniques according to some embodiments of the application.

The electronic device 10 is in some embodiments a mobile terminal, mobile phone or user equipment for operation in a wireless communication system. In other embodiments, the electronic device is a digital camera.

The electronic device 10 comprises an integrated camera module 11, which is linked to a processor 15. The processor 15 is further linked to a display 12. The processor 15 is further linked to a transceiver (TX/RX) 13, to a user interface (UI) 14 and to a memory 16. In some embodiments, the camera module 11 and/or the display 12 is separate from the electronic device and the processor receives signals from the camera module 11 via the transceiver 13 or another suitable interface.

The processor 15 may be configured to execute various program codes 17. The implemented program codes 17, in some embodiments, comprise image capture digital processing or configuration code. The implemented program codes 17 in some embodiments further comprise additional code for further processing of images. The implemented program codes 17 may in some embodiments be stored for example in the memory 16 for retrieval by the processor 15 whenever needed. The memory 15 in some embodiments may further provide a section 18 for storing data, for example data that has been processed in accordance with the application.

The camera module 11 comprises a camera 19 having a lens for focusing an image on to a digital image capture means such as a charged coupled device (CCD). In other embodiments the digital image capture means may be any suitable image capturing device such as complementary metal oxide semiconductor (CMOS) image sensor. The camera module 11 further comprises a flash lamp 20 for illuminating an object before capturing an image of the object. The flash lamp 20 is linked to the camera processor 21. The camera 19 is also linked to a camera processor 21 for processing signals received from the camera. The camera processor 21 is linked to camera memory 22 which may store program codes for the camera processor 21 to execute when capturing an image. The implemented program codes (not shown) may in some embodiments be stored for example in the camera memory 22 for retrieval by the camera processor 21 whenever needed. In some embodiments the camera processor 21 and the camera memory 22 are implemented within the apparatus 10 processor 15 and memory 16 respectively.

The apparatus 10 may in embodiments be capable of implementing multi-frame imaging techniques in at least partially in hardware without the need of software or firmware.

The user interface 14 in some embodiments enables a user to input commands to the electronic device 10, for example via a keypad, user operated buttons or switches or by a touch interface on the display 12. One such input command may be to start a multiframe image capture process by for example the pressing of a ‘shutter’ button on the apparatus. Furthermore the user may in some embodiments obtain information from the electronic device 10, for example via the display 12 of the operation of the apparatus 10. For example the user may be informed by the apparatus that a multiframe image capture process is in operation by an appropriate indicator on the display. In some other embodiments the user may be informed of operations by a sound or audio sample via a speaker (not shown), for example the same multiframe image capture operation may be indicated to the user by a simulated sound of a mechanical lens shutter.

The transceiver 13 enables communication with other electronic devices, for example in some embodiments via a wireless communication network.

It is to be understood again that the structure of the electronic device 10 could be supplemented and varied in many ways.

A user of the electronic device 10 may use the camera module 11 for capturing images to be transmitted to some other electronic device or that is to be stored in the data section 18 of the memory 16. A corresponding application in some embodiments may be activated to this end by the user via the user interface 14. This application, which may in some embodiments be run by the processor 15, causes the processor 15 to execute the code stored in the memory 16.

The processor 15 may then process the digital image in the same way as described with reference to FIG. 4.

The resulting image may in some embodiments be provided to the transceiver 13 for transmission to another electronic device. Alternatively, the processed digital image could be stored in the data section 18 of the memory 16, for instance for a later transmission or for a later presentation on the display 10 by the same electronic device 10.

The electronic device 10 may in some embodiments also receive digital images from another electronic device via its transceiver 13. In these embodiments, the processor 15 executes the processing program code stored in the memory 16. The processor 15 may then in these embodiments process the received digital images in the same way as described with reference to FIG. 4. Execution of the processing program code to process the received digital images could in some embodiments be triggered as well by an application that has been called by the user via the user interface 14.

It would be appreciated that the schematic structures described in FIG. 3 and the method steps in FIG. 4 represent only a part of the operation of a complete system comprising some embodiments of the application as shown implemented in the electronic device shown in FIG. 2.

FIG. 3 shows a schematic configuration for a multi-frame digital image processing apparatus according to at least one embodiment. The multi-frame digital image processing apparatus may include a camera module 11, digital image processor 300, a reference image selector 302, a reference image encoder 304, a residual image encoder 306 and a file compiler 308.

In some embodiments of the application the multi-frame digital image processing apparatus may comprise some but not all of the above parts. For example in some embodiments the apparatus may comprise only the digital image processor 300, reference image selector 302, reference image encoder 304 and residual image encoder 306. In these embodiments the digital image processor 300 may carry out the action of the file compiler 308 and output a processed image to the transmitter/storage medium/display.

In other embodiments of the digital image processor 300 may be the “core” element of the multi-frame digital image processing apparatus and other parts or modules may be added or removed dependent on the current application. In other embodiments, the parts or modules represent processors or parts of a single processor configured to carry out the processes described below, which are located in the same, or different chip sets. Alternatively the digital image processor 300 is configured to carry out all of the processes and FIG. 3 exemplifies the processing and encoding of the multi-frame images.

The operation of the multi-frame digital image processing apparatus parts according to at least one embodiment will be described in further detail with reference to FIG. 4. In the following example the multi-frame image application is a wide-exposure image, in other words where the image is captured with a range of different exposure levels or time. It would be appreciated that any other of the multi-fame digital images as described previously may also be carried using similar processes. Where elements similar to those shown in FIG. 2 are described, the same reference numbers are used.

The camera module 11 may be initialised by the digital image processor 300 in starting a camera application. As has been described previously, the camera application initialisation may be started by the user inputting commands to the electronic device 10, for example via a button or switch or via the user interface 14.

When the camera application is started, the apparatus 10 may start to collect information about the scene and the ambiance. At this stage, the different settings of the camera module 11 may be set automatically if the camera is in the automatic mode of operation. For the example of a wide-exposure multi-frame digital image the camera module 11 and the digital image processor 300 may determine the exposure times of the captured images based on a determination of the image subject. Different analog gains or different exposure values can be automatically detected by the camera module 11 and the digital image processor 300 in a multiframe mode. Where, the exposure value is the combination of the exposure time and analog gain.

In wide-focus multi-frame examples the focus setting of the lens may be similarly determined automatically by the camera module 11 and the digital image processor 300. In some embodiments the camera module 11 may have a semi-automatic or manual mode of operation where the user may via the user interface 14 fully or partially choose the camera settings and the range over which the multi-frame image will operate. Examples of such settings that could be modified by the user include a manually focusing, zooming, choosing a flash mode setting for operating the flash 20, selecting an exposure level, selecting an analog gain, selecting an exposure value, selecting auto white balance, or any of the settings described above.

Furthermore when the camera application is started, the apparatus 10 for example the camera module 11 and the digital image processor 300 may further automatically determine the number of images or frames that will be captured and the settings used for each images. This determination may in some embodiments be based on information already gathered on the scene and the ambiance. In other embodiments this determination may be based on information from other sensors, such as an imaging sensor, or a positioning sensor capable of locating the position of the apparatus. Examples of such positioning sensor are Global positioning system (GPS) location estimators and cellular communication system location estimators, and accelerometers.

Thus in some embodiments the camera module 11 and the digital image processor 300 may determine the range of exposure levels, and/or a exposure level locus (for example a ‘starting exposure level’, a ‘finish exposure level’ or a ‘mid-point exposure level’) about which the range of exposure levels may be taken for the multi-frame digital image application. In some embodiments the camera module 11 and the digital image processor 300 may determine the range of the analog gain and/or the analog gain locus (for instance a ‘starting analog gain’, a ‘finish analog gain’ or a ‘mid-point analog gain’) about which the analog gain may be set for the multi-frame digital image application. In some embodiments the camera module 11 and the digital image processor 300 may determine the range of the exposure value and/or the exposure value locus (for instance a ‘starting exposure value’, a ‘finish exposure value’ or a ‘mid-point exposure value’) about which the exposure value may be set for the multi-frame digital image application. Similarly in some embodiments in wide-focus multi-frame examples the camera module 11 and the digital image processor 300 may determine the range of focus settings, and/or focus setting locus (for example a ‘starting focus setting, a ‘finish focus setting’ or a ‘mid-point focus setting’) about which the focus setting may be set for the multi-frame digital image application.

In some embodiments, the user may furthermore modify or choose these settings and so can define manually the number of images to be captured and the settings of each of these images or a range defining these images.

The initialisation or starting of the camera application within the camera module 11 is shown in FIG. 4 by the step 401.

The digital image processor 300 in some embodiments may then perform a polling or waiting operation where the processor waits to receive an indication to start capturing images. In some embodiments of the invention, the digital image processor 300 awaits an indicator signal which may be received from a “capture” button. The capture button may be a physical button or switch mounted on the apparatus 10 or may be part of the user interface 14 described previously.

While the digital image processor 300 awaits the indicator signal, the operation stays at the polling step. When the digital image processor 300 receives the indicator signal (following the pressing of the capture button), the digital image processor may communicate to the camera module 11 to start to capture several images dependent on the settings of the camera module as determined in the starting of the camera application operation. The processor in some embodiments may perform an additional delaying of the image capture operation where in some embodiments a timer function is chosen and the processor may communicate to the camera module to start capturing images at the end of timer period.

The polling step of waiting for the capture button to be pressed is shown in FIG. 4 by step 403.

On receiving the signal to begin capturing images from the digital image processor 300, the camera module 11 then captures several images as determined by the previous setting values. In embodiments employing wide-exposure multi-frame image processing the camera module may take several subsequent images of the same or substantially same viewpoint, each frame having a different exposure time or level determined by the exposure time or level settings. For example the settings may determine that 5 images are to be taken with linearly spaced exposure times starting from a first exposure time and ending with a fifth exposure time. It would be appreciated that embodiments may have any suitable number of images or frames in a group of images. Furthermore it would be appreciated that the captured image differences may not be linear, for example there may be a logarithmic or other non-linear difference between images.

In a further example, where the camera-flash is the determining factor between image capture frames the camera module 11 may capture two subsequent images, one with flashlight and another without. In a further example the camera module 11 may capture any suitable number of images, each one employing a different flashlight parameter—such as flashlight amplitude, colour, colour temperature, length of flash, inter pulse period between flashes.

In other embodiments where the focus setting is the determining factor between image capture frames the camera module 11 may take several subsequent images with different focus setting. In further embodiments where the zoom factor is the determining factor the camera module 11 may take several subsequent images with different zoom factors (or focal lengths). In further embodiments the camera module 11 may take several subsequent images with different analog gains or different exposure values. Furthermore in some embodiments the subsequent images captured may differ using one or more of the above factors.

In some embodiments the camera module 11, rather than taking subsequent images, in other words serially capturing images one after another may capture multiple images substantially at the same time using a first image capture arrangement to capture a first image with a first setting exposure time, and a second capture arrangement to capture substantially the same image with a different exposure time. In some embodiments, more than two capture arrangements may be used with an image with a different exposure time being captured by each capture arrangement. Each capture arrangement may be a separate camera module 11 or may in some embodiments be a separate sensor in the same camera module 11.

In other embodiments the different capture arrangements may use the same physical camera module 11 but may be generated from processing the output from the capture device. In these embodiments the optical sensor such as the CCD or CMOS may be sampled and the results processed to build up a series of ‘image frames’. For example the sampled outputs from the sensors may be combined to produce a range of values faster than would be possible by taking sequential images with the different determining factors. For example in wide-exposure multi-frame processing three different exposure frames may be captured by taking a first image sample output after a first period to obtain a first image after a first exposure time, a second image sample output a second period after the first period to obtain a second image with a second exposure time and adding the first image sample output to the second image sample output to generate a third image sample output with a third exposure time approximately equal to the first and second exposure time combined.

The camera module 11 may then pass the captured image data to the digital image processor 300 for all of the captured image frame data.

The operation of capturing multi-frame images is shown in FIG. 4 by step 405.

The digital image processor 300 then may pass the captured image data to the reference image selector 302 where the reference image selector 302 is configured to select a reference image from the plurality of images captured.

In some embodiments, the reference image selector 302 determines an estimate of the image visual quality of each image and the image with the best visual quality is selected as the reference. In some embodiments, the reference image selector may determine the image visual quality to be based on the image having a central part in focus. In other embodiments, the reference image selector 302 selects the reference image as the image according to any suitable metrics or parameter associated with the image. In some embodiments the reference image selector 302 selects one of the images dependent on receiving a user input via the user interface 14. In other embodiments the reference image selector 302 performs a first filtering of the images based on some metric or parameter of the images and then the user selects one of the remaining images as the reference image.

These manual or semi-automatic reference image selections in some embodiments are carried out where the digital image processor 300 displays a range of the captured images to the user via the display 12 and the user selects one of the images by any suitable selection means. Examples of selection means may be in the form of the user interface 14 in terms of a touch screen, keypad, button or switch.

The reference image selection is shown in FIG. 4 by step 407.

The digital image processor 300 then sends the selected reference image to the reference image encoder 304 where the reference image encoder may perform any suitable encoding algorithm on the reference image to generate an encoded reference image. In some embodiments the reference image encoder performs a standard JPEG encoding on the referenced image with the JPEG encoding parameters determined either automatically, semi-automatically or manually by the user. The encoded reference image may in some embodiments be passed back to the digital image processor 300.

The encoding of the reference image is shown in FIG. 4 by step 409.

The digital image processor 300 in some embodiments sends the non-reference images to the residual image encoder 306 which then encodes the non-reference images. In some embodiments the digital image processor 300 may also send a copy of the reference image to the residual image encoder 306 so that the residual image encoder 306 may encode the remaining images predictively using the referenced image as a prediction reference image.

Thus in some embodiments the differences, pixel by pixel, between the reference image and each of the other captured images are computed by the residual image encoder 306. For example in colour images, the difference may in some embodiments be computed for each colour component. In some embodiments the residual image encoder 306 may then perform a spatial to frequency domain transform. As the captured images are of the same scene, the images will be similar and therefore the computed and transformed images will likely only contain a few high frequency (details) differences and encoding of these differences will be very efficient. In these embodiments the residual image encoder 306 may encode the differences using a JPEG encoding technique.

In some embodiments where non-reference images are not similar to the reference image, for example where the images are captured with different exposure times or with different analogue gain, the residual image encoder 306 may precode these non-similar images to become more similar to the referenced image. For example the residual image encoder 306 may apply an inverse of the camera response function to transform all captured images in the radiance map domain. In other embodiments, the residual image encoder 306 may apply any suitable transformation as part of a precoding to render the other image frames similar to the reference frame. The residual image encoder 306 may store the type and parameter values of the precoding process into the file. The stored type and parameter values may enable a decoder to perform an inverse precoding process and hence reconstruct a decoded image similar to the captured image before the original image precoding and coding.

In some embodiments the residual image encoder may apply motion compensation transformation coding to the other non-reference images. This motion compensated transform coding may use the reference image as a single reference image source. Alternatively or in addition, the motion compensated transform coding may select one of previously encoded images as a reference image source for a particular part of the image being encoded, while the motion compensated transform coding may select another previously encoded image as a reference image source for another part of the image being encoded. Alternatively or in addition, the motion compensated transform coding may use more than one previously encoded image as a motion compensation transformation reference frame (a secondary reference image) for a particular part of the image being encoded. Typically, a pixel-wise average of two reference image sources may be performed to form a bi-prediction motion compensation encoding system. Alternatively in some embodiments, a pixel-wise weighted average may be used in bi-predictive motion compensation encoding, where the weights may be implicitly derived from capturing parameters or explicitly selected, for example, to form a good prediction signal for the image being encoded. When the weights are explicitly selected, the weights may be also indicated in the same file where the images are stored.

The type of motion compensation transformation applied by the residual image encoder may vary on an image or image segment basis. The type of motion compensation transformation may not in some embodiments be limited to translational motion but any higher degree of a motion model may be used. The residual image encoder may generate an indication of the type of motion compensation transformation in the file for all non-reference images in the file, for each non-reference image separately, for a group of image segments sharing the same type of motion compensation transformation or for each image segment. The residual image encoder may also in some embodiments store other parameter values of the motion compensation transformation, such as motion vectors, into the file.

In other embodiments the residual image encoder 306 may first precode at least one of the non-reference images to become more similar to the reference image as described above and then use the precoded non-reference image as a secondary reference images for bi-prediction or inter-prediction encoding.

In further embodiments the residual image encoder 306 may apply both motion compensation and difference encoding to parts of the image being encoded.

In further embodiments the residual image encoder 306 may resample the prediction reference images before applying predictive coding such as described previously. This re-sampling of the reference image may be particularly useful in embodiments where the different images and frames have different zoom factors. An example of a reference picture re-sampling process is provided by Annex P of ITU-T recommendation H.263.

The residual image encoder 306 then outputs the encoded residual image to the digital image processor 300.

The encoding of the other captured images predictively from other earlier encoded images is shown in FIG. 4 by step 411.

The digital image processor 300 may then pass the encoded image files to the file compiler 308. The file compiler 308 on receiving the encoded reference image and the encoded non-reference image data compiles the data into a single file so that an existing file viewer can still decode and render the referenced image.

Thus in some embodiments the file compiler 308 may compile the file so that the reference image is encoded as a standard JPEG picture and the predictively encoded non-reference images are added as exchangeable image file format (EXIF) data or extra data in the same file.

The file compiler may in some embodiments compile a file where the predictively encoded non-reference images are located as a second or further image file directory (IFD) field of the EXIF information part of the file which as shown in FIG. 1 may be part of a first application data field (APP1) of the JPEG file structure. In other embodiments the file compiler 308 may compile a single file so that the encoded non-reference images are stored in the file as an additional application segment, for example an application segment with a designation APP3. In other embodiments the file compiler 308 may compile a multi-picture (MP) file formatted according to the CIPA DC-007-2009 standard by the Camera & Image Products Association (CIPA). A MP file comprises multiple images (First individual image) 651, (Individual image #2) 653, (individual image #3) 655, (individual image #4) 657, each formatted according to JPEG and EXIF standards, and concatenated into the same file. The application data field APP2 601 of the first image 651 in the file contains a multi-picture index field (MP Index IFD) 603 that can be used for accessing the other images in the same file as indicated in FIG. 7. The file compiler 308 may in some embodiments set the Representative Image Flag in the multi-picture index field to 1 for the reference image and to 0 for the non-reference images. The file compiler 308 furthermore may in some embodiments set the MP Type Code value to indicate a Multi-Frame Image and the respective sub-type to indicate the camera setting characterizing the difference of the images stored in the same file, i.e. the sub-type may be one of exposure time, focus setting, zoom factor, flashlight mode, analog gain, and exposure value.

The file compiler 308 may in some embodiments compile two files. A first file may be formatted according to JPEG and EXIF standards and comprise one of the plurality of images captured, which may be the reference image or the image with the estimated best visual quality. The first file can be decoded with legacy JPEG and EXIF compatible decoders. A second file may be formatted according to an extension of JPEG and/or EXIF standards and comprise the plurality of images captured. The second file may be formatted in a way to enable the file to be not decoded with a legacy JPEG and EXIF compatible decoders. In other embodiments, the file compiler 308 may compile a file for each of the plurality of images captured. The files may be formatted according to JPEG and EXIF standards.

In those embodiments where the file complier 308 compiles at least two files from the plurality of images captured, it may further link the files logically and/or encapsulate them into the same container file. In some embodiments the file compiler 308 may name the at least two files in such a manner that the file names differ only by extension and one file has .jpg extension and is therefore capable of being processed by legacy JPEG and EXIF compatible decoders. The files therefore may form a DCF object according to “Design rule for Camera File system” specification by Japan Electronics and Information Technology Industries Association (JEITA).

In various embodiments the file compiler 308 may generate or dedicate a new value of the compression tag for the non-reference predictively coded images. The compression tag is one of the header fields included in the Application Marker Segment 1 (APP1) of JPEG files. The compression tag typically indicates the decompression algorithm that should be used to reconstruct a decoded image from the compressed image stored in the file. The compression tag of the reference image may in some embodiments be set to indicate a JPEG compression/decompression algorithm. However, as JPEG decoding may not be sufficient for correct reconstruction of the non-reference image or images, a distinct or separate value of the compression tag may be used for the non-reference images.

In these embodiments a standard JPEG decoder may then detect or ‘see’ only one image, the reference image, which has been encoded according to conventional JPEG standards. Any decoders supporting these embodiments will ‘see’ and be able to decode the non-reference images as well as the reference image.

In some other embodiments the file compiler 308 may receive the reference image data and difference data from the non-reference images and concatenate the reference image data with the computed difference data to form a larger image. The resulting image may then be passed to the reference image encoder 304 and JPEG encoded. In such embodiments the reference image is present in the top left corner of the JPEG encoded image and may be indicated by the pixel x dimension and the pixel y dimension EXIF tags inserted into the image file format. In these embodiments a conventional JPEG decoder may decode the full JPEG encoded image but crop the image as one indicated by pixel x dimension and pixel y dimension EXIF tag. In other words a conventional JPEG decoder will output the referenced image.

However in other decoders the JPEG encoded image may be first decoded conventionally and then the decoded image may be split into a decoded reference image (and or images) and the remaining difference images. The original non-reference images may be obtained by summing the decoded reference image and the decoded difference image data separately.

The compiling of reference and non-reference images into a single file operation is shown in FIG. 4 by step 413.

The digital image processor 300 may then determine whether or not the camera application is to be exited, for example, by detecting a pressing of an exit button on the user interface for the camera application. If the processor 300 detects that the exit button has been pressed then the processor stops the camera application, however if the exit button has not been detected as being pressed, the processor passes back to the operation of polling for a image capture signal.

The polling for an exit camera application indication is shown in FIG. 4 by step 415.

The stopping of the camera application is shown in FIG. 4 by operation 417.

An apparatus for decoding a file according to our invention is schematically depicted in FIG. 5. The apparatus comprises a processor 451, a reference image decoder 453 and a residual image decoder 455. In some embodiments, the parts or modules represent processors or parts of a single processor configured to carry out the processes described below, which are located in the same, or different chip sets. Alternatively the processor 451 is configured to carry out all of the processes and FIG. 5 exemplifies the processing and decoding of the multi-frame images.

The processor 451 may receive the encoded file from a receiver or recording medium. In some embodiments the encoded file can be received from another device while in other embodiments the encoded file can be received by the processor 451 from the same apparatus or device, for instance when the encoded file is stored in the device that contains the processor. In some embodiments, the processor 451 passes the encoded file to the reference image decoder 453. The reference image decoder 453 decodes the reference image from the encoded file. In some other embodiments of the invention the processor 451 sends the encoded file to the residual image decoder 453 which extracts and decodes at least one residual image from the encoded file. In some other embodiments, the decoding of the reference and of the residual images is carried out at least partially in the processor 451.

The operation of decoding a multi-frame encoded file according to some embodiments of the application is described schematically with reference to FIG. 6. The decoding process of the multi-frame encoded file may be started by the processor 451 for example when a user switches to the file in an image viewer or gallery application. The operation of starting decoding is shown in FIG. 6 by step 501.

The decoding process may be stopped by the processor 451 for example by pressing an “Exit” button or by exiting the image viewer or gallery application. The polling of the “Exit” button to determine if it has been pressed is shown in FIG. 6 by step 503. If the “Exit” button has been pressed the decoding operation passes to the stop decoding operation as shown in FIG. 6 by step 505.

According to this figure, when the decoding process is started and if the “Exit” button is not pressed (or if the decoding process is not stopped by any other means) the first operation is to select the decoding mode. The selection of the decoding mode according to some embodiments is the selection of decoding in either single-frame or multi-frame mode. In some embodiments, the mode selection can be done automatically based on the number of images stored in the encoded file, i.e., if the file comprises multiple images, a multi-frame decoding mode is used. In some other embodiments, the capturing parameters of various images stored in the file may be examined and the image having capturing parameter values that are estimated to suit user preferences (adjustable for example through a user interface (UI)), capabilities of the viewing device or application, and/or viewing conditions, such as the amount of ambient light, is selected for decoding. For example, if the file is indicated to contain two images and also contains an indication that the two images are intended for displaying on a stereoscopic display device, but the viewing device only is a conventional monoscopic (two-dimensional) display, the processor 451 may determine that a single-frame decoding mode is used. In another example, a file comprises two images differing may have an indicator which indicates that the images differ in their exposure time. An image with the longer exposure time, hence a bright picture compared to the image with the shorter exposure time, may be selected by the processor 451 for viewing when there is a large amount of ambient light detected by the viewing device. In such an example the processor may, if the image selected for decoding is the reference image, select the single-frame decoding mode; otherwise, the processor may select the multi-frame decoding mode is used. In other embodiments the selection of the mode is done by the user for instance through a user interface (UI). The selection of the mode of decoding is shown in FIG. 6 by step 507.

If the selected mode is single-frame then only the reference image is decoded and shown on the display. The determination of whether the decoding is single or multi-frame is shown in FIG. 6 by step 509. The decoding of only the reference image is shown in FIG. 6 by step 511. The showing or displaying of only the reference image is shown in FIG. 6 by step 513.

If the selected mode is multi-frame, the reference image and at least one residual image are decoded. The decoding of the reference image as the first image to be decoded for the multi-frame decoding operation is shown in FIG. 6 by step 515. In some embodiments the number of residual images that are extracted from the encoded file can be automatically selected by the residual image decoder 455 while in some other embodiments this number can be selected by the user through an appropriate UI. In some other embodiments the residual images to be decoded together with the reference image can be selected manually by the user through an UI. The selection of the number and which of the images are to be decoded is shown in FIG. 6 by step 517.

In some embodiments, the decoding of a residual image comprises the operation of identifying the compression type used for generating the residual image. The operation of identification of the compression type used for the residual image may comprise interpreting a respective indicator stored in the file. If the compression type indicator indicates that prediction from other images is not used in compression, such as in the case of JPEG compression, decoding the residual image may comprise performing in the residual image decoder 455 the processing steps for image decoding, such as rescaling of quantized transform coefficients and an inverse transform from a transform domain to a pixel domain.

Where the compression type indicator indicates that prediction from other images is used to generate the file, decoding of the residual image may comprise performing in the residual image decoder 455 the processing steps of decoding the difference or prediction error image, decoding a type and parameters of predictive coding, such as motion vectors, from the file, and adaptively combining the difference image and the previously decoded image or images on the basis of the type and parameters of predictive coding. The steps of the decoding of the residual image may be done on a block by block basis. Decoding the difference image may comprise performing in the residual image decoder 455 the processing steps for image decoding for a single non-referenced image as described above.

The operation of adaptive combination the difference image and the previously decoded image may comprise performing in the residual image decoder 455 the processing steps of determining a prediction block within a previously decoded image on the basis of a motion vector and summing pixel-wise the respective colour component values of a prediction block and a difference block. If the precoding type and parameters are indicated in the file, the decoding of a residual image may further comprise performing in the residual image decoder 455 an inverse process for the precoding. It is noted that the inverse process for the precoding may also be approximate, i.e. in the cascaded process of precoding and inverse precoding the original pixel values may be approximately but not necessarily exactly reconstructed. The operation of decoding the images in the multi-frame mode of decoding is shown in FIG. 6 by step 519.

Thus in some embodiments of the application there is a method comprising the operations of capturing a first image of a subject with a first image capture parameter and at least one further image of substantially the same subject with at least one corresponding further image capture parameter, encoding the first image into a first encoded image, encoding the at least one further image into at least one further encoded image, and combining the first encoded image and the at least one further encoded image into a first file.

In some other embodiments of the application there is a method comprising the operations of decoding a first file comprising a first encoded image and at least one further encoded image, the first image having been captured of a subject with a first image capture parameter and the at least one further image having been captured of substantially the same subject with at least one further image capture parameter. In such embodiments the operation of decoding the first file comprises the operations of determining at least one of the first encoded image and the at least one further encoded image to be decoded, and decoding the at least one of the first encoded image and the at least one further encoded image.

Furthermore in some embodiments there may be an apparatus comprising at least one processor and at least one memory including computer program code the at least one memory and the computer program code configured to, with the at least one processor, cause the apparatus at least to perform the operations described above.

For example in some embodiments there may be an apparatus comprising a camera module configured to capture a first image of a subject with a first image capture parameter and at least one further image of substantially the same subject with at least one associated further image capture parameter, a reference image encoder configured to encode the first image into a first encoded image, a further image encoder configured to encode the at least one further image into at least one further encoded image, and a file compiler configured to combine the first encoding image and the at least one further encoded image into a first file.

Also in some embodiments there may be an apparatus configured to decode a first file comprising a first encoded image having been captured of a subject with a first image capture parameter and at least one further encoded image having been captured of substantially the same subject with at least one further image capture parameter, the apparatus comprising a processor configured to determine at least one of the first encoded image and the at least one further encoded image to be decoded; and a decoder configured to decode the at least one of the first encoded image and the at least one further encoded image.

In some embodiments, after the reference and the selected residual images have been decoded at least one of them are shown on the display and the decoding process is restarted for the next encoded file. The operation of showing or displaying some or all of the decoded images is shown in FIG. 6 by step 521.

In other embodiments, the reference and the selected residual images are not shown on the display, but may be processed by various means. For example, the reference and the selected residual images may be combined into one image, which may be encoded again for example by a JPEG encoder, and it may be stored in a file located in a storage medium or transmitted to further apparatus.

It shall be appreciated that the term user equipment is intended to cover any suitable type of wireless user equipment, such as mobile telephones, portable data processing devices or portable web browsers. Furthermore user equipment, universal serial bus (USB) sticks, and modem data cards may comprise apparatus such as the apparatus described in embodiments above.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

As used in this application, the term circuitry may refer to all of the following: (a) hardware-only circuit implementations (such as implementations in only analogue and/or digital circuitry) and (b) to combinations of circuits and software (and/or firmware), such as and where applicable: (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of circuitry applies to all uses of this term in this application, including in any claims. As a further example, as used in this application, the term circuitry would also cover an implementation of merely a processor (or multiple processors) or portion of a processor and its (or their) accompanying software and/or firmware. The term circuitry would also cover, for example and if applicable to the particular claim element, a baseband integrated circuit or applications processor integrated circuit for a mobile phone or a similar integrated circuit in server, a cellular network device, or other network device.

The term processor and memory may comprise but are not limited to in this application: (1) one or more microprocessors, (2) one or more processor(s) with accompanying digital signal processor(s), (3) one or more processor(s) without accompanying digital signal processor(s), (3) one or more special-purpose computer chips, (4) one or more field-programmable gate arrays (FPGAS), (5) one or more controllers, (6) one or more application-specific integrated circuits (ASICS), or detector(s), processor(s) (including dual-core and multiple-core processors), digital signal processor(s), controller(s), receiver, transmitter, encoder, decoder, memory (and memories), software, firmware, RAM, ROM, display, user interface, display circuitry, user interface circuitry, user interface software, display software, circuit(s), antenna, antenna circuitry, and circuitry.

1.-45. (canceled)

46. A method comprising:
capturing a first image of a subject with a first image capture parameter and at least one further image of substantially the same subject with at least one corresponding further image capture parameter, wherein the first image and the at least one further image are captured within a period being perceived as a single event;
encoding the first image into a first encoded image;
encoding the at least one further image into at least one further encoded image; and
combining the first encoded image and the at least one further encoded image into a first file.

47. The method as claimed in claim 46, wherein encoding the at least one of the further image comprises:
decoding the first encoded image into a first decoded image;
determining the differences between at least part of one of the at least one further image and at least part of the first decoded image; and
encoding the differences between at least part of one of the at least one further image and at least part of the first decoded image.

48. The method as claimed in claim 46, wherein combining the first encoded image and the at least one further encoded image into a first file comprises: configuring the first file be decodable according to a first algorithm and a second algorithm;
the first encoded image being decodable into a first decoded image representing the first image according to the first algorithm and the second algorithm; and
the at least one further encoded image being decodable into at least one further decoded image representing the at least one further image only according to the second algorithm.

49. The method as claimed in claim 46, wherein combining the first encoded image and the at least one further encoded image into a first file comprises:
logically linking the first encoded image and the at least one further encoded image in the first file, wherein the first encoded image and the at least one further encoded image are configured to share a same coded data structure.

50. The method as claimed in claim 46, wherein capturing the first image and the at least one further image is in response to a user action.

51. The method as claimed in claim 46, further comprising:
determining the number of at least one further images to be captured.

52. The method as claimed in claim 46, further comprising:
selecting an image capture parameter value for each image to be captured, wherein each image capture parameter comprises at least one of:
exposure time;
focus setting;
zoom factor;
background flash mode;
analog gain; and
exposure value.

53. The method as claimed in claim 46, further comprising
inserting a first indicator in the first file indicating at least one of the first image capture parameter and the at least one further image capture parameter type.

54. The method as claimed in claim 46, wherein capturing a first image and the at least one further image comprises at least one of:
capturing the first image and subsequently capturing each of the at least one further image; and
capturing the first image substantially at the same time as capturing each of the at least one further image.

55. A method comprising:
decoding a first file comprising a first encoded image and at least one further encoded image, the first image having been captured of a subject with a first image capture parameter and the at least one further image having been captured of substantially the same subject with at least one further image capture parameter, wherein decoding the first file comprises:
determining at least one of the first encoded image and the at least one further encoded image to be decoded;
decoding the at least one of the first encoded image and the at least one further encoded image.

56. The method as claimed in claim 55 comprising:
decoding the first encoded image by a first decoding algorithm to form a first decoded image;
decoding the at least one further encoded image to generate at least one further image prediction data; and
generating at least one further decoded image by combining the first decoded image and the at least one further image prediction data.

57. The method as claimed in claim 55, wherein
the first file comprises:
at least one first indicator indicating at least one of the first image capture parameter type and the at least one further image capture parameter type, and
at least one second indicator indicating at least one of a first image capture parameter value and at least one further image capture parameter value;
wherein the determining at least one of the first encoded image and the at least one further encoded image to be decoded comprises interpreting at least one of the first indicator the at least one second indicator.

58. The method as claimed in claim 55 further comprising
determining a number of decoded images from the first encoded file to be decoded, wherein the number of decoded images to be decoded is selected by a user.

59. The method as claimed in claim 55, wherein
all encoded images from the first encoded file are decoded.

60. The method as claimed in claim 55, further comprising selecting the encoded images from the first encoded file which are to be decoded, wherein the encoded images to be decoded are selected by the user.

61. An apparatus comprising at least one processor and at least one memory including computer program code the at least one memory and the computer program code configured to, with the at least one processor, cause the apparatus at least to:
capture a first image of a subject with a first image capture parameter and at least one further image of substantially the same subject with at least one associated further image capture parameter, wherein the first image and the at least one further image are captured within a period being perceived as a single event;
encode the first image into a first encoded image;
encode the at least one further image into at least one further encoded image; and
combine the first encoding image and the at least one further encoded image into a first file.

62. The apparatus as claimed in claim 61, wherein when causing the apparatus to encode the at least one further image further comprises causing the apparatus to::
decode the first encoded image into a first decoded image;
determine the differences between at least part of one of the at least one further image and at least part of the first decoded image; and
encode the differences between at least part of one of the at least one further image and at least part of the first decoded image.

63. The apparatus as claimed in claim 61, wherein when causing the apparatus to combine the first encoded image and the at least one further encoded image into a first file further comprises causing the apparatus to:logically link the first encoded image and the at least one further encoded image in the first file, wherein the first encoded image and the at least one further encoded image are configured to share a same coded data structure

64. The apparatus as claimed in claim 61, wherein the capture of the first image and the at least one further image is in response to a user action.

65. The apparatus as claimed in claim 61, wherein the apparatus is further caused to determine the number of at least one further image to be captured.

66. The apparatus as claimed in claim 61, wherein the apparatus is further caused to select an image capture parameter value for each image to be captured, wherein each image capture parameter comprises at least one of:
exposure time;
focus setting;
zoom factor;
background flash mode;
analog gain; and
exposure value.

67. The apparatus as claimed in claim 61, wherein the apparatus is further caused to insert a first indicator in the first file indicating at least one of the first image capture parameter and the at least one further image capture parameter type.

68. The apparatus as claimed in claim 61, wherein when causing the apparatus to capture a first image and the at least one further image further comprises causing the apparatus to at least one of:
capture the first image and subsequently one or more further images; and
capture the first image substantially at the same time as capturing each of the further images.

69. An apparatus comprising at least one processor and at least one memory including computer program code the at least one memory and the computer program code configured to, with the at least one processor, cause the apparatus at least to:
decode a first file comprising a first encoded image having been captured of a subject with a first image capture parameter and at least one further encoded image having been captured of substantially the same subject with at least one further image capture parameter, the apparatus further caused to:
determine at least one of the first encoded image and the at least one further encoded image to be decoded; and
decode the at least one of the first encoded image and the at least one further encoded image.

70. The apparatus as claimed in claim 69, wherein the apparatus is further caused to :
decode the first encoded image by a first decoding algorithm to form a first decoded image;
decode the at least one further encoded image to generate at least one image prediction data; and
generate at least one further decoded image by combining the first decoded image and the at least one image prediction data.

71. The apparatus as claimed in claim 69, wherein the first file comprises:
at least one first indicator indicating at least one of the first image capture parameter type and the at least one further image capture parameter type, and
at least one second indicator indicating at least one of a first image capture parameter value and at least one further image capture parameter value;
wherein when causing the apparatus to determine the at least one of the first encoded image and the at least one further encoded image to be decoded further comprises causing the apparatus to interpret at least one of the first indicator the at least one second indicator.

72. The apparatus as claimed in claim 69, wherein the apparatus is further caused to determine a number of decoded images from the first encoded file to be decoded, wherein the number of decoded images to be decoded is selected by a user.

73. The apparatus as claimed in claim 69, wherein all encoded images from the first encoded file are decoded.

74. The apparatus as claimed in claim 69, wherein the apparatus is further caused to select the encoded images from the first encoded file which are to be decoded, wherein the encoded images to be decoded are selected by the user.
